(19) United States
(12) Patent Application Publication
(10) Pub. No.: US 2001/0006890 A1
(43) Pub. Date: Jul. 5, 2001

(54) Method for providing user inquired information by character in communication system

(75) Inventor: Hwan-Chul Ryu, Songnam-shi (KR)

Correspondence Address: Steve S. Cha, Esq, KLAUBER & JACKSON, Continental Plaza, 411 Hackensack Avenue, Hackensack, NJ, 07601, US

(73) Assignee: SAMSUNG ELECTRONIC CO., LTD.

(21) Appl. No.: 09/740,292

(22) Filed: Dec. 19, 2000

(30) Foreign Application Priority Data
Dec. 22, 1999 (KR) 1999-60187

(51) Int. Cl. H04M 3/42

(52) U.S. Cl. 455/414; 455/517; 455/563

(57) ABSTRACT

A method for providing the information inquired by a mobile terminal subscriber via an information service center having a voice recognition function. When a call is set up between the information service center and a mobile terminal, the information service center transmits an outgoing message to the mobile terminal. In response, the mobile terminal transmits a voice response in response to the outgoing message from the information service center. The information service center recognizes the user's voice and searches a specific information corresponding to the recognized voice. The information service center transmits the searched information in voice signal to the mobile terminal. The mobile terminal outputs the searched information provided from the information service center, and transmits a request for character information of the searched information to the information service center as occasion demands. The information service center then transmits the character information to the mobile terminal in response to the user's request. The mobile terminal outputs the transmitted character information, and transmits another request for additional information to the information service center. The information service center transmits the additional information to the mobile terminal in response to the user's request. The mobile terminal outputs the additional information received from the information service center to the user.

This application claims priority to an application entitled “Method for Providing User Inquired Information by Character in Communication System” filed in the Korean Industrial Property Office on Dec. 22, 1999 and there duly assigned Serial No. 99-60187.

### BACKGROUND OF THE INVENTION

1. Field of the Invention

The present invention relates generally to an information service in a communication system, and in particular, to a method for providing the information inquired by the user in characters.

2. Description of the Related Art

Generally, the user of a mobile terminal or a wire telephone makes a call connection to the information service center to obtain the telephone or address information of a third party or entity. When the user inquires a desired phone number from an operator, the operator typically speak out the phone number inquired by the user in person or transmits the information through an automated computer voice.

However, when inquiring information from the information center in a noisy environment, the user experiences difficulty in hearing the voice information transmitted from the operator. Hence, the user has to make a call connection again to the information center to obtain the same information.

### SUMMARY OF THE INVENTION

It is, therefore, an object of the present invention to provide a method to ensure that the information inquired by the user from an information service center is successfully received by the user.

It is another object of the present invention to provide a method for recording the information transmitted from the information center in response to the user's request without making a manual note, and subsequently making a call connection using the recorded information.

To achieve the above and other objects according to another aspect, the present invention is a method of providing user inquired information through an information service center with a voice recognition function. When a call is set up between the information service center and a mobile terminal, the information service center transmits an outgoing message to the mobile terminal. In response, the mobile terminal transmits a voice response in response to the outgoing message from the information service center. The information service center recognizes the user's voice and searches a specific information corresponding to the recognized voice. The information service center transmits the searched information in voice signal to the mobile terminal. The mobile terminal outputs the searched information provided from the information service center, and transmits a request for character information of the searched information to the information service center as occasion demands. The information service center then transmits the character information to the mobile terminal in response to the user's request. The mobile terminal outputs the transmitted character information, and transmits another request for additional information to the information service center. The information service center transmits the additional information to the mobile terminal in response to the user's request. The mobile terminal outputs the additional information received from the information service center to the user.

### BRIEF DESCRIPTION OF THE DRAWINGS

The above and other objects, features, and advantages of the present invention will become more apparent from the following detailed description when taken in conjunction with the accompanying drawings in which:

FIG. 1 is a schematic block diagram of a communication system according to an embodiment of the present invention;

FIG. 2 is a block diagram of the information service center of FIG. 1 according to an embodiment of the present invention;

FIG. 3 is a flow diagram illustrating a procedure for providing user inquired information according to an embodiment of the present invention;

FIG. 4 is a flow chart illustrating a procedure for providing user inquired information according to another embodiment of the present invention; and

FIG. 5 is a flow chart illustrating a procedure for processing information received at a mobile terminal according to an embodiment of the present invention.

### DETAILED DESCRIPTION OF THE PREFERRED EMBODIMENT

A preferred embodiment of the present invention will be described herein below with reference to the accompanying drawings. For the purpose of clarity, well-known functions or constructions are not described in detail since they would obscure the invention in unnecessary detail.

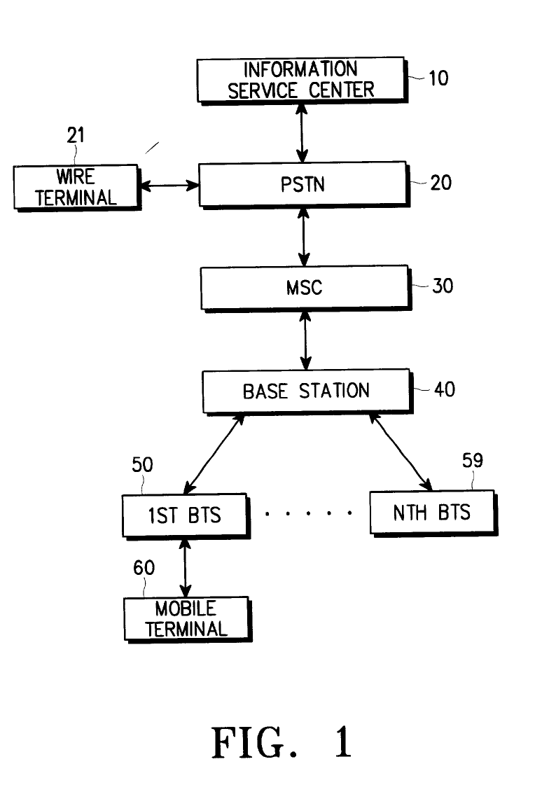

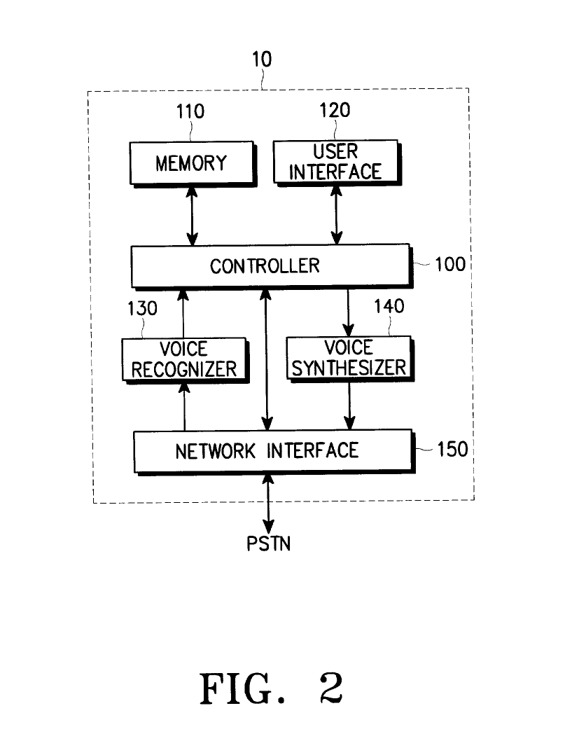

A description of a network for providing information service according to an embodiment of the present invention will be made below with reference to FIGS. 1 and 2.

Referring to FIG. 1, a radio network according to an embodiment of the present invention includes a mobile terminal (or mobile phone) 60, a plurality of base station transceiver systems (BTSs) 50-59, a base station (BS) 40 and a mobile switching center (MSC) 30. The radio network is connected to a PSTN (Public Switched Telephone Network) 20 to which an information service center 10 is connected thereto. The mobile terminal 60 is registered in the first BTS 50 and performs radio communication with other mobile terminals (not shown) or a wire terminal (or wire telephone) 21 coupled to the PSTN 20. The BTSs 50-59 are wirelessly connected to a plurality of mobile terminals and perform data exchange with the mobile terminals. The BTSs 50-59 are connected to the base station 40, which provides communication paths between the BTSs 50-59 and the mobile switching center 30. The mobile switching center 30 is connected to the PSTN 20 and provides a communication path between the mobile terminal 60 and the wire terminal 21 coupled to the PSTN 20. The mobile switching center 30 manages the overall operation of the radio network.

Referring to FIG. 2, the information service center 10 is comprised of a controller 100, a memory 110, a user interface 120, a voice recognizer 130, a voice synthesizer 140 and a network interface 150. Although the information service center 10 is connected to the PSTN 20 in FIG. 1, it can also be connected to the mobile switching center 30. The information service center 10 can provide an information service either by a voice synthesizer or by an operator. The controller 100 controls the overall operation of the information service center 10, and in particular, provides various information in character or voice in response to the information inquiry from the user according to an embodiment of the present invention. The memory 110 stores the phone directory including subscribers' names and addresses in association with their phone numbers, and can also store the postal codes of the subscriber's addresses. That is, the memory 110 stores the phone numbers corresponding to the names being inquired by the user. The user interface 120 is used to update data in the memory 110 and manage the information service center 10. The user interface 120 is comprised of a display (e.g., LCD (Liquid Crystal Display)), a key input section, a microphone, and a speaker. The voice recognizer 130 analyzes the voice received at the information service center 10 and generates related parameters for the information service. The voice synthesizer 140 provides the searched information via voice signals. For example, when the inquired phone number is “111-4444”, the voice synthesizer 140 will generate voice information of “The phone number you have inquired is one-one-one-four-four-four-four”. The network interface 150 connected to the PSTN 20 or the mobile switching center 30 performs interfacing between the information service center 10 and the PSTN 20 or the mobile switching center 30.

A description of a procedure for performing an information service according to an embodiment of the present invention will now be made with reference to FIGS. 1 to 3. Although the present invention will be described with reference to a phone number information service, it should be noted that it can also be applied to different information service.

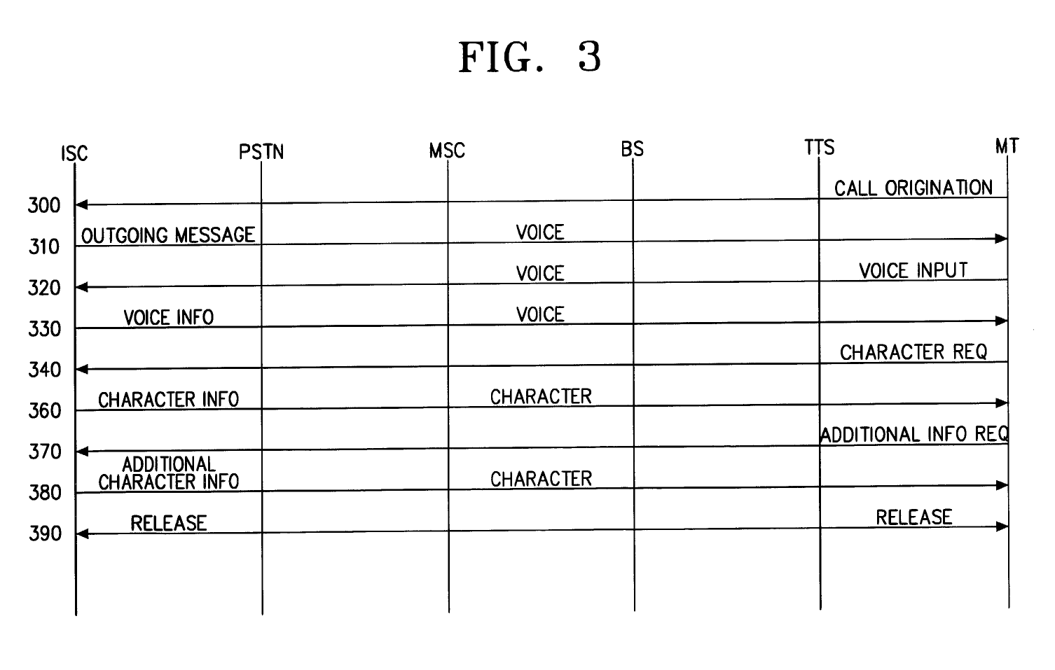

Referring to FIG. 3, in step 300, a user of the mobile terminal (MT) 60 attempts to make a call connection to the information service center (ISC) 10. When the call connection is established, the information service center 10 transmits an outgoing message to the mobile terminal 60 in step 310. More specifically, the controller 100 of the information service center 10 reads the outgoing message previously stored in the memory 110 and transmits the read outgoing message to the mobile terminal 60 through the PSTN 20, the mobile switching center 30, the base station 40 and the BTS 50. For example, the outgoing message can be “Please, utter the name whose phone number you desire to know, and then press *-key”. In response to the outgoing message, the user of the mobile terminal 60 will then utter the name whose phone number he or she desires to know and presses *-key, in step 320.

The information service center 10 can request the user to input an additional parameter, when necessary. That is, when there exist many persons having the same name, the information service center 10 may transmit a more specific outgoing message to instruct the user, such as “Please, utter an address of the person whose phone number you desire to know, and then press *-key”. At the same time, if, for example, the user's utterance is not recognizable, the information service center 10 may transmit an additional outgoing message such as “Please, utter again”.

Thereafter, the information service center 10 analyzes the voice uttered by the user through the voice recognizer 130 and generates a parameter for conducting data search. That is, the information service center 10 digitalizes the voice uttered by the user. The controller 100 of the information service center 10 searches the memory 110 for the information corresponding to the voice uttered by the user. Then, the controller 100 synthesizes the corresponding voice through the voice synthesizer 140 and transmits the synthesized voice information to the mobile terminal 60 in step 330. Here, the controller 100 requests for additional response. For example, the synthesized voice information may be “The phone number you have inquired is one-one-one-four-four-four-four, and if you need a character message, please press *-key”.

At this time, if the user of the mobile terminal 60 can not hear the voice information provided from the information service center 10 due to the noisy background or if he or she desires to take a personal note of the requested phone number, the user requests the information service center 10 to provide the corresponding character information in step 340. The information service center 10 then transmits the character information corresponding to the earlier transmitted voice information to the mobile terminal 60 in step 360. At this point, the controller 100 transmits the character information through the network interface 150 rather than through the voice synthesizer 150. The character information can be transmitted according to the “Calling Party ASCII Number” or “Type-specific fields” as set forth under the TSB-80 specification of Table 1 or the IS-95B specification of Table 2.

TABLE 1

| Information Element | Direction | Type |
|---|---|---|
| Protocol Discriminator | BS −> MSC | M |
| Reserved-Octet | BS −> MSC | M |
| Message Type | BS −> MSC | M |
| Calling Party BCD Number | MSC −> BS | O |
| Called party BCD Number | BS −> MSC | O |
| Signal | MSC −> BS | O |
| Display | MSC −> BS | O |
| Message with Indication | MSC −> BS | O |
| Calling Party ASCII Number | MSC −> BS | O |
| Tag | MSC −> BS | O |

TABLE 2

| Field | Length (bits) |
|---|---|
| MSG-TYPE (‘00001110’) | 8 |
| ACK SEQ | 3 |
| MSG SEQ | 3 |
| ACK REQ | 1 |
| ENCRYPTION | 2 |
| RECORD_TYPE | 8 |
| RECORD_LEN | 8 |
| Type-specific fields | 8 × RECORD_LEN |
| Reserved | 7 |

The mobile terminal 60 outputs the received character information to the display unit. When the user needs an additional information, the received character information may include an additional information request message such as “The number you have inquired is 111-4444, and if you need additional information, please press *-key”.

Thereafter, if the user requests additional information in step 370, the information service center 10 transmits additional information of the character information, to the mobile terminal 60 in step 380. The additional information can be provided through a short message service (SMS). The additional information may include a subscriber's address of the transmitted phone number. Finally, in step 390, the call is released at the request of the mobile terminal 60 or the information service center 10.

The invention has been described with reference to the information service center 10 having a voice recognition function according to the present invention. However, in the existing information service center, which is typically managed by an operator, the steps 310, 330, 360 and 380 can be performed by an actual person. That is, the operator searches the phone number inquired by the user of the mobile terminal 60 and informs the user of the searched phone number using the voice synthesizer 140. Similarly, the information service center 10 can provide character information of the phone number and provide the user with the additional information by character or voice signals.

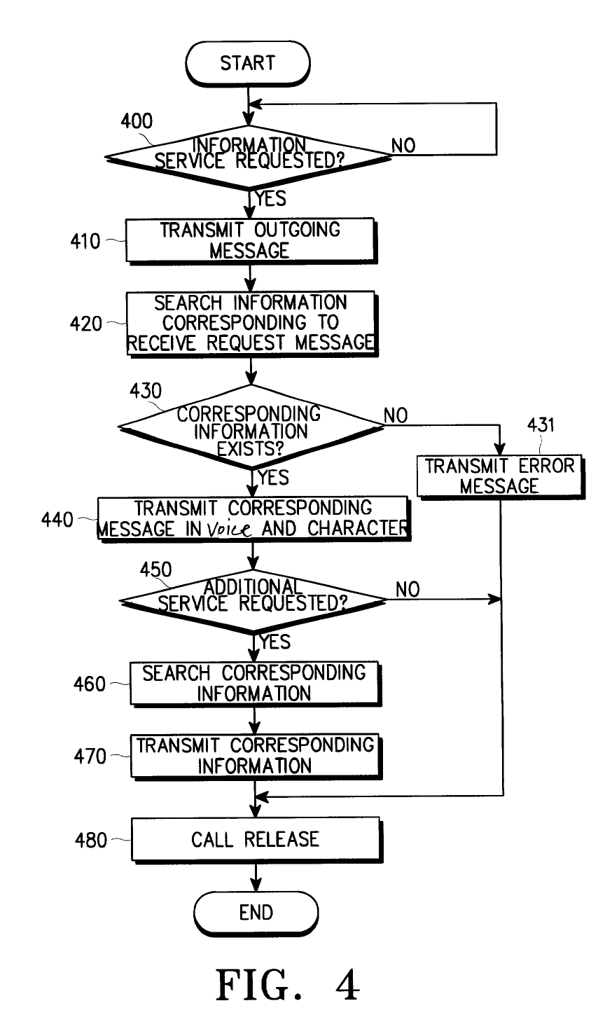

FIG. 4 illustrates a procedure for providing an information service in an information service which is managed by an operator according to another embodiment of the present invention.

Referring to FIG. 4, when the user of the mobile terminal 60 makes a call to the information service center 10 in step 400, an operator of the information service center 10 transmits an outgoing message to the mobile terminal 60 in step 410. That is, unlike the embodiment of FIG. 3, the operator personally speaks out an outgoing message, such as “Please, give me a name of a person whose phone number you desire to know”. The user of the mobile terminal 60 will then tell the operator the name of the person being inquired. Then, in step 420, the operator inputs a search parameter through the user interface 120 to search the inquired phone number. If the inquired phone number exists in step 430, the controller 100 of the information service center 10 transmits the searched phone number in both voice and character signals, in step 440. At this point, the character information can be transmitted by “Calling Party ASCII Number” of the TSB-80 specification in Table 1 or “Type-specific fields” of the IS-95B specification in Table 2, as described with reference to the embodiment of FIG. 3. However, if the inquired phone number does not exist in step 430, an error message is generated in step 431. The error message can be generated through the voice synthesizer 140 using a previously recorded error message or informed by operator directly.

If an additional service request message is received from the user of the mobile terminal 60 in step 450, the controller 100 of the information service center 10 searches the corresponding information in step 460. Thereafter, the controller 100 transmits the searched information in step 470. The mobile terminal 60 will then display the additionally searched information received from the information service center 10 on its display unit. Here, the additional information can be provided using the SMS function. As stated above, the additional information may include an address of the user having the inquired phone number. Finally, in step 480, the call between the mobile terminal 60 and the information service center 10 is released.

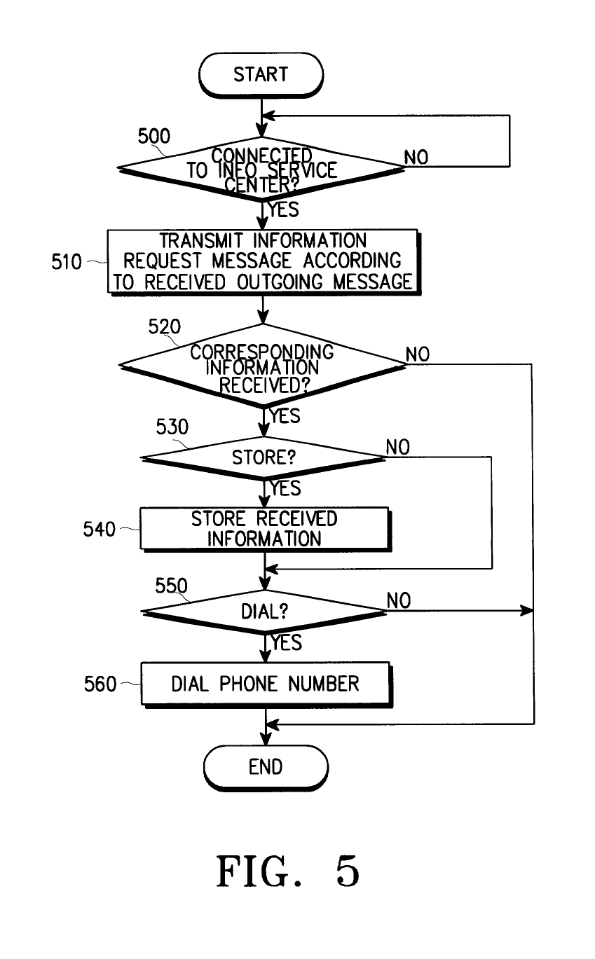

FIG. 5 illustrates a procedure for storing and managing the user inquired character information received at the mobile terminal according to another embodiment of the present invention.

Referring to FIG. 5, the user of the mobile terminal 60 makes a call connection to the information service center 10 in step 500, and transmits an information request message for obtaining desired information in response to the outgoing message transmitted from the information service center 10 in step 510. For example, the information request message is a name of the person whose phone number the user desires to know. When corresponding character information is received in response to the information request message in step 520, the mobile terminal 60 determines whether to store the received character information in step 530. Hence, when the received character information is a phone number, the mobile terminal 60 has an option to store the phone number in a phone directory allocated in a memory (not shown) in step 540. Thereafter, if the user desires to dial the received phone number in step 550, the mobile terminal 60 will dial the phone number in step 560.

To sum up, when the mobile terminal user transmits a character service request for a specific information to the information service center, the information service center provides the corresponding information via characters using the SMS function according to the “Calling Party ASCII Number” or “Type-specific fields” of the TSB-80 or IS-95B specifications. In this manner, it is possible to ensure the receipt of the user inquired information, and also record the user inquired information without making a personal note manually.

While the invention has been shown and described with reference to a certain preferred embodiment thereof, it will be understood by those skilled in the art that various changes in form and details may be made therein without departing from the spirit and the scope of the invention as defined by the appended claims.

What is claimed is:

1. A method for providing information inquired by a subscriber of a mobile terminal in communication with an information service center having a voice recognition function, the method comprising the steps of:
upon establishing a call connection between the information service center and the mobile terminal, transmitting an outgoing message from the information service center to the mobile terminal;
transmitting a voice response by the mobile terminal subscriber responsive to the outgoing message from the mobile terminal to the information service center;
recognizing at the information service center the voice response transmitted from the mobile terminal;
searching information corresponding to the recognized voice response at the information service center;
transmitting the searched information from the information service center to the mobile terminal; and
displaying the searched information transmitted from the information service center in the mobile terminal.

2. The method as claimed in claim 1, wherein the searched information transmitted from the information service center to the mobile terminal is a character message.

3. The method as claimed in claim 1, wherein the searched information is transmitted to the mobile terminal using a short message service (SMS) function.

4. The method as claimed in claim 1, wherein the searched information is transmitted to the mobile terminal according to the “Calling Party ASCII Number” set forth under the TSB-80 specification.

5. The method as claimed in claim 1, wherein the searched information is transmitted to the mobile terminal according to the “Type-specific fields set forth under the IS-95B specification.

6. The method as claimed in claim 1, further comprising the steps of:
storing the searched information provided from the information service center in a memory of the mobile terminal; and
upon receiving a request from the subscriber, releasing the call between the information service center and the mobile terminal to establish a call connection according to the searched information provided from the information service center.

7. The method as claimed in claim 1, further comprising the steps of:
generating a corresponding voice message when the searched information is transmitted to the mobile terminal in voice signal;
transmitting a request for a character message in response to the searched information from the mobile terminal to the information service center;
in response to the character message request, transmitting the character message corresponding to the searched information from the information service center to the mobile terminal; and
displaying the character message transmitted from the information service center in the mobile terminal.

8. A method for providing an information inquired by a user through an information service center, comprising the steps of:
upon establishing a call connection between the information service center and a mobile terminal, transmitting a voice input by the mobile terminal user to the information service center;
searching information by an operator of the information service center in response to the user's voice;
transmitting the searched information to the mobile terminal in character signals; and
displaying, at the mobile terminal, the searched character information transmitted from the information service center.

9. The method as claimed in claim 8, further comprising the steps of:
storing the searched information in the mobile terminal;
releasing the call connection between the information service center and the mobile terminal in response to the user's request; and
establishing a connection using the searched information.

10. The method as claimed in claim 8, wherein the searched information is transmitted to the mobile terminal according to the “Calling Party ASCII Number” set forth under the TSB-80 specification.

11. The method as claimed in claim 8, wherein the searched information is transmitted to the mobile terminal according to the “Type-specific fields set forth under the IS-95B specification.

12. A method for providing an information inquired by a user through an information service center, comprising the steps of:
establishing a call connection between the information service center and a mobile terminal;
transmitting an outgoing message requesting an input by the mobile terminal from the information service center to the mobile terminal;
transmitting a character request message by the user responsive to the outgoing message to the information service center;
upon receiving the request message, searching a specific information corresponding to the character request message in the information service center and transmitting the searched information to the mobile terminal; and
displaying, at the mobile terminal, the searched information provided from the information service center.

13. The method as claimed in claim 12, further comprising the steps of:
in response to a user's request, storing the searched information transmitted from the information service center;
releasing the call connection between the information service center and the mobile terminal; and
making a call using the searched information by the mobile terminal.

14. The method as claimed in claim 12, wherein the searched information is transmitted to the mobile terminal according to the “Calling Party ASCII Number” set forth under the TSB-80 specification.

15. The method as claimed in claim 12, wherein the searched information is transmitted to the mobile terminal according to the “Type-specific fields set forth under the IS-95B specification.

16. The method as claimed in claim 12, wherein the searched information is transmitted in character or voice signals to the mobile terminal from the information service center.

17. A method for providing an information inquired by a user through an information service center, comprising the steps of:
upon establishing a call connection between the information service center and a mobile terminal, transmitting an outgoing message from the information service center to the mobile terminal;
transmitting a voice response by the user in response to the outgoing message from the mobile terminal to the information service center;
recognizing the user's voice response in the information service center;
searching a specific information corresponding to the recognized voice response in the information service center;
transmitting the searched information in voice signals to the mobile terminal;
displaying the searching information provided from the information service center by the mobile terminal;
transmitting a request for a character information responsive the searched information to the information service center by the user;
transmitting the requested character information from the information service center to the mobile terminal;
upon transmitting the requested character information, transmitting a request for additional information of the information to the information service center by the user;
transmitting the additional information searched by the information service center to the mobile terminal; and
displaying the additional information received from the information service center in the mobile terminal.
